(19) United States
(12) Patent Application Publication
(10) Pub. No.: US 2025/0078836 A1
(43) Pub. Date: Mar. 6, 2025

(54) Face Mask for Capturing Speech Produced by a Wearer

(71) Applicant: Telefonaktiebolaget LM Ericsson (publ), Stockholm (SE)

(72) Inventors: Konstantinos Vandikas, Solna (SE); Kristijonas Cyras, San Jose, CA (US); Sandhya Baskaran, Chennai (IN)

(21) Appl. No.: 18/718,080

(22) PCT Filed: Mar. 8, 2022
(86) PCT No.: PCT/SE2022/050220

§ 371 Date: Jun. 10, 2024

(30) Foreign Application Priority Data
Dec. 30, 2021 (GR) 20210100925

(51) Int. Cl. G10L 15/25; G10L 15/26

(52) U.S. Cl. CPC G10L 15/25; G10L 15/26

(57) ABSTRACT

A face mask (200) is disclosed that is configured to capture speech produced by a wearer of the face mask. The face mask (200) includes a plurality of sensors (202) adapted to capture changes in shape of a part of a face of the wearer while producing speech. The face mask (200) also includes a processing circuitry adapted to receive data from the plurality of sensors (202). the data representing changes in shape of a part of the face of the wearer. and to classify the data received from the plurality of sensors (202) into one or more units of speech using a machine learning model. A related method and a related computer program product are also disclosed.

### TECHNICAL FIELD

The present disclosure relates to a face mask for capturing speech produced by a wearer of the face mask, a method by a face mask for capturing speech produced by a wearer of the face mask, and a corresponding computer program product.

### BACKGROUND

One of the well-known consequences of the COVID-19 pandemic is the increasingly common use of a face mask. Face masks have been shown to be effective in stopping the spread of the virus. This finding has generated an interest which has greatly boosted the production of such masks with varying properties ranging from surgical masks and cloth-based masks to N95 face masks and KN95 face masks.

There are several known solutions for capturing speech of a person wearing a face mask. One such solution is based on placing a microphone on the outside of the face mask. However, the audio captured by such a microphone is often muffled and resembles that of speaking through a gag, which can degrade experience of communication, e.g., when engaged in a phone call.

An alternative is to provide a microphone inside the face mask, such as MaskFone™ and Xupermask™. In such systems, a microphone converts received sounds into audio signal for transmission. However, the sounds received by the microphone include not only the wearer's voice but, inhaling/exhaling noise as well. When the wearer inhales, the sound of gas flow through the mask's breathing regulator is often particularly loud and is transmitted as noise having a large component comparable in both frequency and intensity to the sounds made by a person when speaking. Accordingly, additional effort needs to be placed in the design of the microphone to eliminate unwanted sounds caused by inhaling/exhaling.

Beyond microphone-based solutions, mask-like devices in the area of silent-speech control interfaces can be used as an input device. The overall goal of devices with silent-speech interfaces is to recognize silent speech for controlling consumer wearables. For example, A. Bedri et al., “Toward Silent-Speech Control of Consumer Wearables,” in Computer (vol. 48, issue 10, pp. 54-62, IEEE, 2015) discloses a tongue-mounted magnet to learn specific commands for controlling consumer wearables. However, this approach requires invasive prosthetics. In another example, Suzuki Y. et al., “A Mouth Gesture Interface Featuring a Mutual-Capacitance Sensor Embedded in a Surgical Mask,” in: Kurosu M. (eds) Human-Computer Interaction. Multimodal and Natural Interaction, (HCII 2020), pp. 154-165, Lecture Notes in Computer Science, vol. 12182, Springer, 2020) discloses a surgical mask with embedded mutual-capacitance sensors, which allows recognizing basic non-verbal mouth gestures.

### SUMMARY

It is an object of the invention to provide an improved alternative to the above techniques and prior art. More specifically, it is an object of the invention to provide improved solutions for capturing speech produced by a wearer of a face mask.

Some embodiments of the present disclosure are directed to a face mask for capturing speech produced by a wearer of the face mask. The face mask includes sensors adapted to capture changes in shape of a part of a face of the wearer while producing speech. The face mask also includes a processing circuitry adapted to receive data from the sensors, the data representing the changes in shape of the part of the face of the wearer. The data received from the plurality of sensors is classified into units of speech using a machine learning model.

Some other related embodiments are directed to a method by a face mask for capturing speech produced by a wearer of the face mask. The method includes receiving data from sensors comprised in the face mask, the data representing changes in shape of a part of a face of the wearer while producing speech, and classifying the data received from the plurality of sensors into units of speech using a machine learning model.

Some other related embodiments are directed to a computer program product for capturing speech produced by a wearer of a face mask. The computer program product includes a non-transitory computer readable medium storing program code that is executable by at least one processor of the face mask to perform operations including receiving data from sensors comprised in the face mask, the data representing changes in shape of a part of a face of the wearer while producing speech, and classifying the data received from the plurality of sensors into units of speech using a machine learning model.

Potential advantages of one or more of these embodiments may include that the face mask is able to capture speech produced by the wearer of the face mask without, or to lesser extent, capturing unwanted sounds caused by inhaling/exhaling.

Other devices, methods, and computer program products according to embodiments will be or become apparent to one with skill in the art upon review of the following drawings and detailed description.

### BRIEF DESCRIPTION OF THE DRAWINGS

Aspects of the present disclosure are illustrated by way of example and are not limited by the accompanying drawings. In the drawings:

FIG. 1 illustrates the main parts of a human body used to produce speech sounds;

FIG. 2a illustrates a face mask with an array of sensors adapted to capture changes in shape of a part of a face of a wearer while producing speech, in accordance with some embodiments of the present disclosure;

FIG. 2b illustrates a face mask where different sensors within the array of sensors are affected due to the changes in shape of the part of the face of the wearer, in accordance with some embodiments of the present disclosure;

FIG. 3 schematically illustrates a face mask that is communicatively connected to a communications device through a network and configured to operate in accordance with some embodiments of the present disclosure;

FIG. 4 schematically illustrates face masks that are communicatively connected to each other configured to operate in accordance with some embodiments of the present disclosure;

FIG. 5 is a sequence diagram illustrating a centralized training process, in

accordance with some embodiments of the present disclosure;

FIG. 6 is a sequence diagram illustrating a federated training process, in accordance with some embodiments of the present disclosure;

FIG. 7a depicts an example sequence-to-sequence model architecture of a Long Short-Term Memory (LSTM) encoder and decoder, in accordance with some embodiments of the present disclosure;

FIG. 7b exemplarily illustrates graphs plotted in different points in time that correspond to different shapes of the face when the wearer speaks a word, in accordance with some embodiments of the present disclosure;

FIG. 8 illustrates a flowchart illustrating a method by a face mask capturing speech produced by a wearer from the changes in shape of the part of the face of the wearer, in accordance with some embodiments of the present disclosure;

FIG. 9a is a block diagram illustrating a data processing system, where data transmitted between a sender's face mask and a receiver's communication device is processed, in accordance with some embodiments of the present disclosure;

FIG. 9b exemplarily illustrates a wireframe illustrating different sensors in a face mask affected by the changes in shape of the part of the face at time step 0 (t₀), in accordance with some embodiments of the present disclosure;

FIG. 9c exemplarily illustrates a wireframe illustrating different sensors in a face mask affected by the changes in shape of the part of the face at time step 1 (t₁), in accordance with some embodiments of the present disclosure;

FIG. 10 is a block diagram illustrating a data processing system, where data transmitted between a sender's face mask and a receiver's communication device is processed in a cloud computing system, in accordance with some embodiments of the present disclosure;

FIG. 11 is a block diagram illustrating a data processing system, where data transmitted between a sender's face mask and a receiver's communication device, including text-to-speech conversion, is processed in a cloud computing system, in accordance with some embodiments of the present disclosure;

FIG. 12 is a block diagram illustrating steps involved in data processing of data transmitted between a sender's face mask and a receiver's communication device in a personal device environment, in accordance with some embodiments of the present disclosure;

FIG. 13 is a block diagram illustrating steps involved in data processing of data transmitted between a sender's face mask and a receiver's communication device in a hybrid environment, in accordance with some embodiments of the present disclosure; and

FIG. 14 schematically illustrates a system comprising a face mask that is communicatively connected to a Virtual-Reality (VR) device and a headset through any short-range communications protocol and configured to operate in accordance with some embodiments of the present disclosure.

### DETAILED DESCRIPTION

Inventive concepts will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of various present inventive concepts to those skilled in the art. It should also be noted that these embodiments are not mutually exclusive. Components from one embodiment may be tacitly assumed to be present/used in another embodiment.

A face mask, a method, and a computer program product, are disclosed that capture speech produced by a wearer of the face mask from changes in shape of a part of a face of the wearer while producing speech. The wearer, in the context of this invention is a human being. The face mask includes sensors adapted to capture the changes in shape of the part of the face of the wearer while producing speech. The face mask also includes a processing circuitry adapted to receive data from the sensors, the data representing the changes in shape of the part of the face of the wearer while producing speech, i.e., while the wearer is speaking. The data received from the sensors is classified into units of speech using a machine learning model.

The units of speech may, e.g., be phonemes, graphemes, phones, syllables, articulations, utterances, vowels, consonants, or any combination thereof. In one embodiment, speech is generated from the units of speech. In another embodiment, text is generated from the units of speech. The generation of the speech or text may be performed on a communication device communicatively connected to the face mask, such as a smartphone. The generation of the speech or text may alternatively be performed on a cloud computing system. In yet another embodiment, data representing units of speech may be transmitted to a communication device associated with a receiver of the speech produced by the wearer. The communication device associated with the receiver may be adapted to generate speech or text from the received units of speech.

The speech produced by the wearer may be vocalized speech or subvocalized speech. In an embodiment, speech is captured from changes in shape of a part of a face of the wearer while speaking. This part of the face includes articulators that abut the face mask. The movement of the articulators are commensurate with the speech produced by the wearer. While producing speech, the wearer's articulators are continuously moving. The articulatory movement is continuously measured by the sensors, which then transmit data representing the measured articulatory movement to the processing circuitry for subsequent processing. In comparison with speech captured in a conventional way using a microphone for converting sound into an oscillating electrical current, speech captured from changes in shape of the face of the wearer which represent articulatory movements are more robust since it is less affected by background noise, in particular inhaling/exhaling noise. Hence, the face mask does not require ambient noise cancellation to mitigate unwanted background noise. The captured data representing the articulatory movements of the wearer may be transmitted in the form of adjacency matrices. This data in the form of adjacency matrices may require lower network bandwidth during transmission than conventional speech data.

The face mask includes a plurality of sensors adapted to capture changes in shape of a part of a face of the wearer while speaking. In an embodiment, the part of the face may, e.g., include the region where the buccolabial group of muscles is located. The buccolabial muscles enable movements of the mouth and lips. The function of the buccolabial muscles is to control the shape and movements of the mouth and lips, such as closing, protruding, and compressing, the lips. Performing these actions, buccolabial muscles facilitate speech and help in producing various facial expressions, such as anger, sadness, and others.

Various embodiments of the present disclosure are described in the context of a face mask that includes a plurality of sensors adapted to capture changes in shape of a part of a face of the wearer while producing speech, and a processing circuitry. The plurality of sensors are arranged in the form of an array. The number of sensors required in the face mask depends on the level of accuracy required in capturing speech of the wearer. An increased number of sensors in the face mask results in the face mask being able to capture the speech produced by the wearer more accurately. This is the case since a face mask with an increased number of sensors captures changes in shape of the part of the face of the wearer more accurately. The data from the array of sensors captures the changes in shape of the part of the face and may be represented in the form of adjacency matrices.

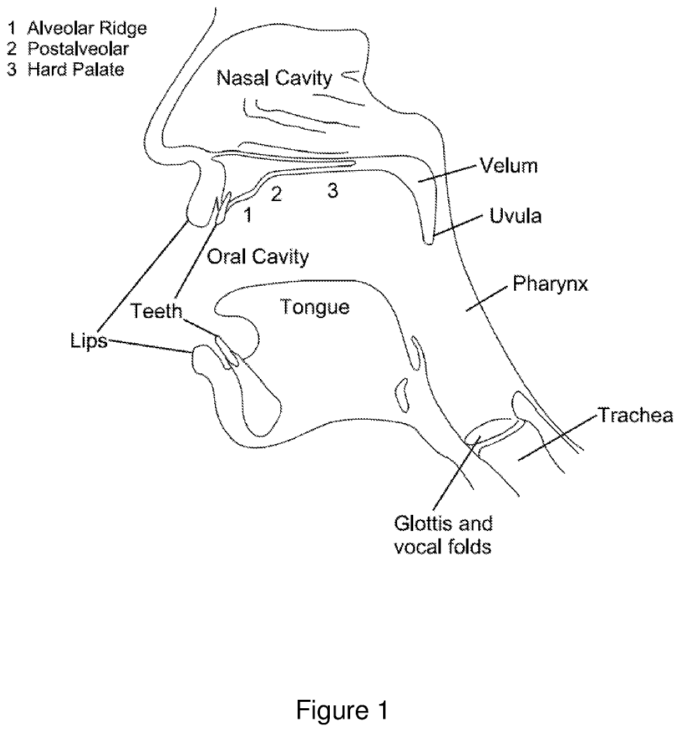

In an embodiment, the face mask is adapted to abut certain facial muscles of the wearer including articulators that are exposed to the face mask. The face mask captures changes in shape of a part of a face of the wearer. In the following, reference is made to FIG. 1 which illustrates the main articulators in a human body which are used to produce speech sounds. An array of sensors in the face mask are placed such that they cover facial muscle of the wearer, including articulators, such as mouth and lips, when worn. The main articulators in a human body are the tongue, the lips, the teeth, the alveolar ridge, the hard palate, the velum, the uvula, the pharynx, the glottis, and the vocal folds. Together with the lungs, these articulators form the vocal tract. The vocal tract is normally divided into two sections: the subglottal vocal tract and the supraglottal vocal tract. The subglottal vocal tract is a part of the larynx situated immediately below the vocal cords until the trachea. The supraglottal vocal tract is situated between the base of tongue and the vocal cords. In general, the speech organs of the subglottal vocal tract provide the source of energy for speech production, whereas the supraglottal vocal tract determines the speech quality.

Most of all speech sounds are produced using an outward flow of air from the lungs as the energy source. The flow of air being released from the lungs in a quasi-periodic manner results in the process by which the vocal folds produce certain sounds through quasi-periodic vibration, known as phonation. Speech produced in this manner is commonly referred to as voiced speech. The airstream from the lungs passes through the glottis and enters the pharynx. The pharynx can be adjusted with tongue movement and depending on the state of the velum, the airstream flows into the oral or the nasal cavity. The shape of the oral cavity can be varied with the tongue position, extent to which the jaw is opened, and the shape of the lips. Different shapes of the oral cavity may lead to different speech sounds.

The two major classes that speech sounds are categorized into are vowels and consonants. Vowels are produced by varying the shape of the pharyngeal and oral cavities such that the airflow from the glottis is relatively unobstructed. Consonants are generally formed by either constricting or blocking the airstream by using the tongue, teeth, and lips. Consonants can be either voiced or unvoiced and are commonly described by the place and manner of articulation. The place of articulation refers to the location in the vocal tract where the constriction is made, whereas the manner of articulation refers to the degree to which the airstream is constricted. Each of the different lineaments of facial muscles result in different shapes of the oral cavity causing a subset of sensors within the array of sensors to produce a unique measured value.

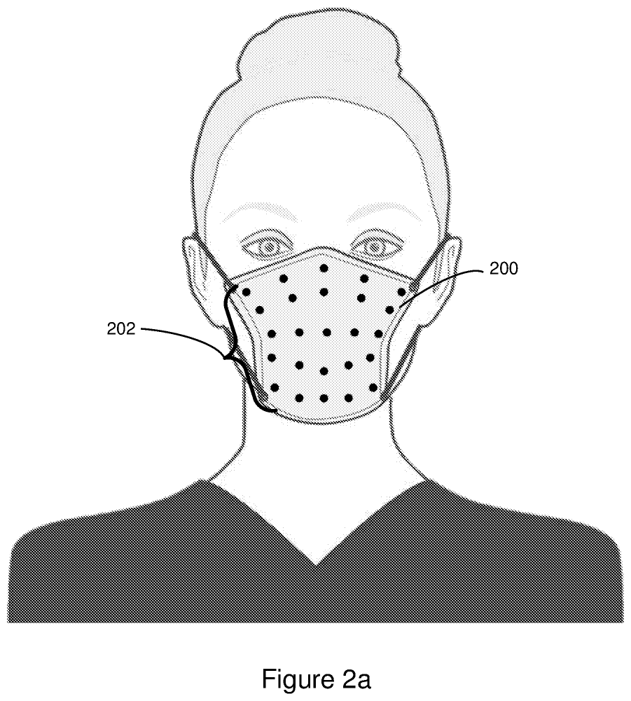

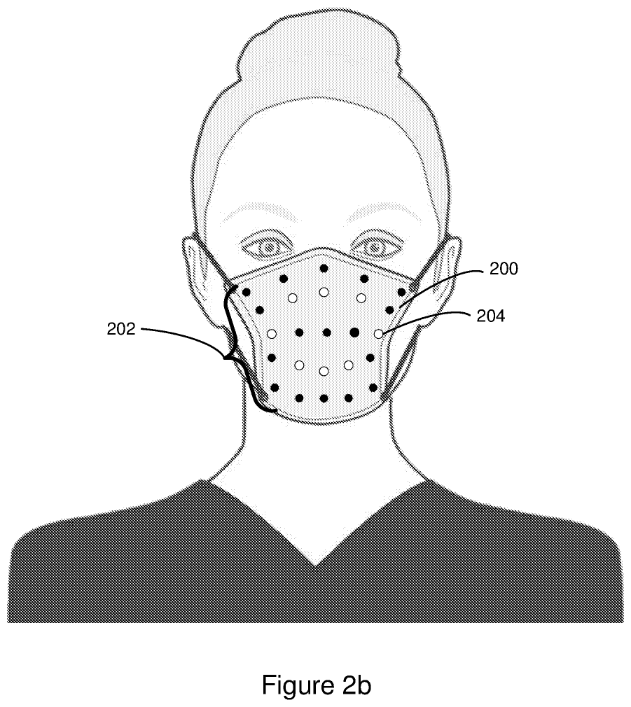

FIG. 2a illustrates a face mask 200 with an array of sensors 202 adapted to capture changes in shape of a part of a face of a wearer while producing speech. In an example, the face mask 200 may be a surgical face mask, an N95 respirator type face mask or a cloth-based face mask. Surgical face masks and N95 respirators are manufactured using non-woven fabrics made from plastics like polypropylene, while cloth-based face masks are made from woven natural or artificial fibers. The array of sensors 202 are disposed along a layer of the face mask, either on an outer layer of the face mask 200 abutting the face of the wearer when worn, or embedded into the face mask 200. The array of sensors 202 may be, for example, woven into, embedded within, or placed on the layer of the face mask 200. In an example, a sensor in the array of sensors 202 may be a piezoelectric strain sensor. The piezoelectric strain sensors generate charge or voltage in presence of strain, i.e., they transduce mechanical strain into electrical signals. Piezoelectric strain sensors are known to have a high gauge factor and are hence used for capturing very small strains. Alternatively, any sensor capable of converting strain or pressure caused by a movement of facial muscles into an electrical signal may be used, such as textile strain sensors or stretch sensors.

A sensor in the array of sensors 202, disposed along the layer of the face mask 200, experiences changes in its electrical characteristics when a portion of the face mask where the sensor is located is stretched. The change in electrical characteristics from the sensor may, e.g., be represented as a normalized number between a minimum value and a maximum value, e.g., “0” and “1”, where “0” represents no strain and “1” represents the highest amount of strain that can be measured. The electrical characteristics can include changes in capacitance, resistance, impedance, inductance, voltage, current, etc. The changes in electrical characteristics, such as voltage, may be encoded as an analog signal representing the changes in the shape of the part of the face of the wearer while speaking. This analog signal may be fed into an analog-to-digital converter (ADC). The ADC takes the analog signal from the sensor as input and converts the analog signal to digital information, which is then output to the processing circuitry for subsequent processing. An advantage of capturing the changes in shape of the part of the face of the wearer while speaking by measuring changes in electrical characteristics of the sensors is that the speech produced by the wearer can be captured without any background noise, in particular inhaling/exhaling noise.

The face mask 200 may be arranged to be fastened around the wearer's face using, for example, stretchable bands connecting the face mask 200 on one end and looping around the wearer's cars on the other end. The position of the face mask 200 on the wearer's mouth remains substantially fixed upon fastening. Therefore, the location of the sensors in the array of sensors 202 also remains substantially fixed relative to the wearer's mouth due to the array of sensors 202 being embedded on the face mask 200. As the wearer moves her/his mouth while wearing the mask, the sensors 202 produce data representing the changes in shape of a part of a face of the wearer while producing speech. The sensors 202 are adapted to continuously capture the changes in shape of the part of the face of the wearer while producing speech. The measurements captured by different sensors affected by the changes in shape of the part of the face of the wearer represent the speech produced by the wearer. The data representing the changes in shape of the part of the face may include distances between sensors 202 and/or positions of the sensors 202.

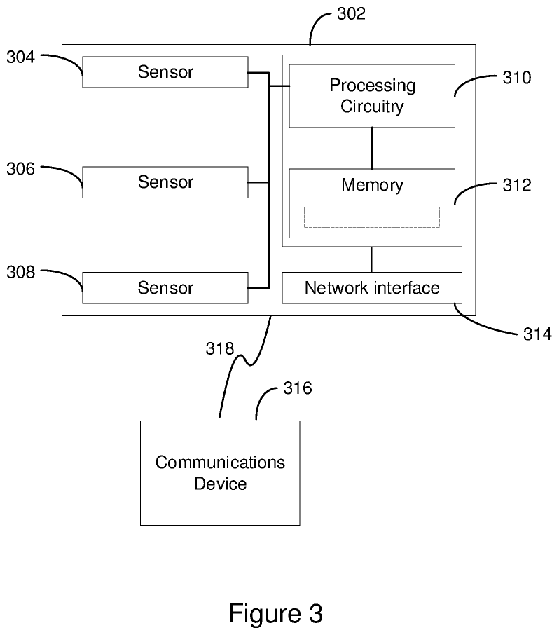

The sensors 202 communicate the data representing the changes in shape of the part of the face of the wearer to a processing circuitry (not shown in FIG. 2a). The processing circuitry is configured to receive data from the array of sensors 202. In one example, the data received from the array of sensors 202 represents strain or pressure data from each individual sensor of the array of sensors 202. Referring to FIG. 3, a face mask 302 which is communicatively connected 318 to a communications device 316 over any short-range communications protocol, is schematically illustrated. The face mask 302 comprises sensors, i.e., sensor 304, sensor 306, and sensor 308, a processing circuitry 310, and a network interface 314.

The processing circuitry 310 may classify the data received from the array of sensors 202 into units of speech using a machine learning model. The units of speech may include phonemes, graphemes, phones, syllables, articulations, utterances, vowels, consonants, or any combination thereof. In one embodiment, data representing the units of speech is communicated to the communications device 316 via the network interface 314. The data representing the units of speech may be communicated to the communications device 316 over any short-range communications protocol. The communications device 316 may generate speech or text from the data representing the units of speech. The communications device 316 may then communicate the speech or text to an external recipient. The communications device 316 may be any one of a smartphone, a mobile phone, a tablet, a laptop, a smartwatch, a media player, a Personal Digital Assistant (PDA), a Head-Mounted Display (HMD) device, an Augmented Reality (AR) device, a Virtual Reality (VR) device, a Mixed Reality (MR) device, a home assistant, an autonomous vehicle, and a drone. In another embodiment, the data representing the units of speech may be communicated to a cloud computing system. The generation of the speech or the text is then performed on the cloud computing system. In an alternative embodiment, the data representing the units of speech may be communicated directly to a communications device of the external recipient over any short-range communications protocol. The communications device of the external recipient may then generate speech or text from the units of speech.

In some embodiments, the processing circuitry 310 may also be configured to send control signals to the array of sensors 202. For example, the processing circuitry 310 may calibrate a sensor 304 in the array of sensors 202 by sending a control signal to the sensor 304. The processing circuitry 310 may also turn the sensor 304 off or on. For example, the processing circuitry 310 may send a control signal which disables the sensor 304, thereby minimizing power required by the sensor 304. The processing circuitry 310 may also send a control signal to turn off the sensor 304 in response to data from other sensors (sensor 306 and sensor 308) in the array of sensors 202. For example, some sensors, such as the sensor 304 may be turned off to conserve power source if the face mask 302 is detected to not be in use. When the face mask 302 is detected to not be in use, the processing circuitry 310 may maintain only select sensors in “on” position. When the face mask 302 is detected to again be in use by the wearer, i.e., for example, when the wearer starts speaking, the processing circuitry 310 may reactivate, or turn on, the remaining sensors.

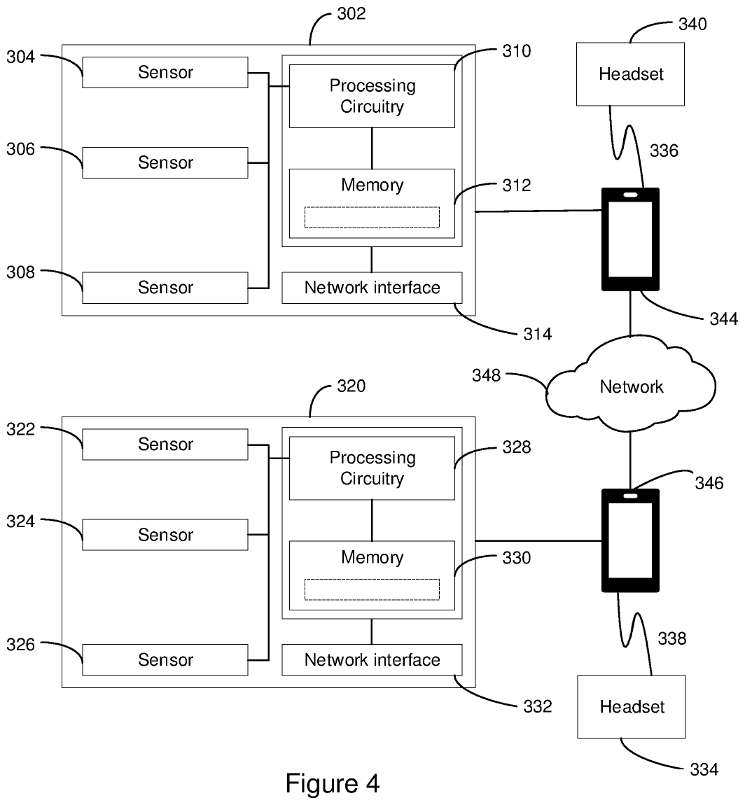

FIG. 4 schematically illustrates face masks, the face mask 302 and a face mask 320, that are communicatively connected to each other through a network 348, a communications device 344 and a communications device 346, and configured to operate in accordance with some embodiments of the present disclosure. The face mask 302 is communicatively connected to an audio outputting device, such as a headset 340 over any short-range communications protocol. Likewise, face mask 320 is communicatively connected to a headset 334 over any short-range communications protocol. The audio outputting device may include a loudspeaker, a sound card etc. Face mask 302 comprises sensors, i.e., sensor 304, sensor 306, and sensor 308, the processing circuitry 310, a memory 312 and a network interface 314. The face mask 320 comprises sensors, i.e., sensor 322, sensor 324, and sensor 326, the processing circuitry 328, a memory 330 and a network interface 332. The headset 340 may be communicatively connected 336 with the communications device 344 and the headset 334 may be communicatively connected 338 with the communications device 346 over any short-range communications protocol.

In an example illustrating the flow of communication, a wearer of face mask 302 connected to headset 340 engages in a phone call over network 348 with a wearer of face mask 320 connected with the headset 334. Face mask 302 may connect to a communications device 344 and face mask 320 may connect to a communications device 346 over any short-range communications protocol. When the wearer of face mask 302 speaks, processing circuitry 310 receives data representing changes in shape of the part of the face of the wearer of face mask 302 from the sensors, sensor 304, sensor 306, and sensor 308. The data representing the changes in shape of the part of the face may include distances between the sensors and/or the positions of the sensors. The processing circuitry 310 classifies the data into units of speech using a machine learning model. The communications device 344 may then generate speech from the data representing the units of speech. The generated speech is subsequently communicated to communications device 346 over network 348. Alternatively, the data representing the units of speech is transmitted directly to the communications device 346 over any short-range communications protocol. The communications device 346 then generates the speech from the data representing the units of speech. Communications device 346 then outputs the generated speech using the headset 334.

The face mask 302 may, for example, register each of the wearers of the face mask 302 and create and store a personalized profile for each registered wearer. The personalized profile may store a personal vocabulary specific to the wearer and a personalized machine learning model. The personalized profile associated with the face mask 302 may be, for example stored in the memory 312 and the personalized profile associated with the face mask 320 may be, for example stored in the memory 330. The personalized profile may be transferrable to another face mask 200 by the wearer.

FIG. 2b illustrates the face mask 200 where different sensors within the array of sensors 202 are affected due to movement of facial muscles of the wearer, i.e., changes in shape of the face of the wearer. A movement of facial muscles of the wearer of the face mask 200 results in speech. The face mask 200 captures the data representing the changes in shape of the part of the face of the wearer, which is received from the array of sensors 202 disposed along the layer of the face mask 200. The data representing the changes in shape of the part of the face of the wearer corresponds to the speech produced by the wearer. The array of sensors 202 in the face mask 200 are placed to be in proximity with the facial muscles of the wearer including articulators such as mouth and lips that are typically exposed to the layers of the face mask 200.

As illustrated in FIG. 2b, the movement of facial muscles affects some sensors within the array of sensors 202, such as sensor 204. The sensors affected by the movement of facial muscles of the wearer produce data representing the changes in shape of the part of the face of the wearer. The data produced by the affected sensors and the corresponding speech produced by the wearer are used in training a machine learning model. During an initial phase of the training, a sample set of words are spoken by wearers of the face mask 200, causing movement of facial muscles of the wearers. The data corresponding to the sample set of spoken words, produced by affected sensors, is captured. The captured data and the corresponding sample set of words spoken by the wearers form an initial dataset. This initial dataset including the data produced by affected sensors and the corresponding sample set of spoken words, is used in training the machine learning model. The machine learning model is then used to further capture speech produced by the wearer from the changes in shape of the part of the face of the wearer.

In an embodiment when the wearer wears the face mask 200, an optional calibration may take place, during which the wearer is requested to speak a few utterances, or a sample set of words. Thereafter, the face mask 200 simply rests on the wearer's face so that machine learning model learns the strain values from the array of sensors 202. In an example, the strain values can then be used as a reference while the face mask 200 captures the wearer's speech. In such a manner, the machine learning model builds the personalized profile for the wearer of the face mask 200. In one embodiment, the personalized machine learning model stored in the personalized profile of the wearer may be collated with personalized machine learning models associated with other wearers to produce a collaborative training model. When the face mask 200 is worn in a different position on the face of the wearer or if there is a malfunction with sensors in the array of sensors 202, or if the face mask 200 detects a deviation higher than a predefined threshold between the measured strain values, the calibration phase can be re-initiated. Such an observation can be prompted as a notification to the communications device 316 communicatively connected to the face mask 200 of the wearer, to re-position the face mask 200 or to re-calibrate the strain values.

The location information of each sensor in the array of sensors 202 is used to identify the measurements produced by the sensor. Alternatively, the measurements from each sensor may be represented alongside the unique identifier of the sensor. This type of data representation is known as a coordinate matrix. Data representation in the form of coordinate matrices typically require less data storage in comparison with data representation in the form of standard dense matrix structures. As an alternate to row and column type representation, the location information of each sensor can be represented relatively from a single point of reference on the grid. For example, data measured from each sensor of the array of sensors 202 is represented alongside the location of each sensor as a difference between the single point of reference on the grid and the sensor.

The electrical characteristics from the sensors are represented with respect to different location coordinates on the face mask 200. Thereafter, a grid-to-graph sequence face modelling is used to reconstruct the image of the wearer's facial muscles. As illustrated in FIG. 2a, each sensor within the array of sensors 202 is connected to the adjacent sensor in the form of a grid. In this example, every sensor is sensitive to strain. The distance between each sensor in the array of sensors 202 changes over time as the wearer's face moves while using the face mask 200. The grid can naturally be represented as a graph where the vertices in the graph are the array of sensors 202 and the edges in the graph are the connections between each of the sensors. The graph is mathematically defined as a set of vertices V which are connected with edges E. Therefore, the graph G is represented as a factor of {E,V}, which is then used to reconstruct the image of the wearer's facial muscles. The reconstructed image is modelled using a semi-supervised learning approach for object localization using Convolutional Neural Network (CNN) to identify an emotional state of the wearer, such as grin, frown etc. The emotional state of the wearer is determined during the speech using Generative Adversarial Networks (GANs) trained over the wearer's voice sample and generalization. As the machine learning model progressively learns to identify various emotional states of the wearer, the machine learning model becomes accurate in capturing speech produced by the wearer of the face mask 200.

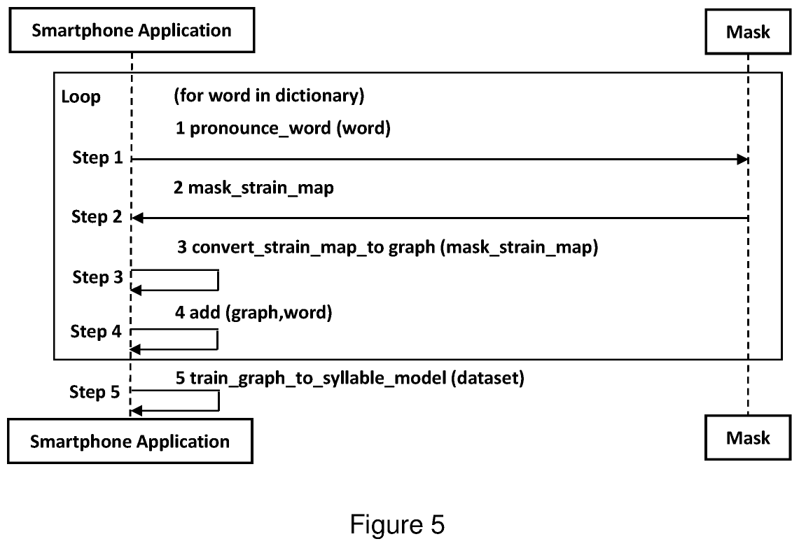

FIG. 5 is a sequence diagram exemplarily illustrating a training of a graph-to-syllable model, in accordance with some embodiments of the present disclosure. In one embodiment, the training of the graph-to-syllable model is performed on the communications device 316. In step 1, an application on the communications device 316 requests the wearer to pronounce a specific word, i.e., for example, a combination of syllables or phonemes. The face mask 200, in response to the specific word, generates a strain map, in step 2. In step 3, the application converts the strain map into a graph. In step 4, the application adds the graph and the corresponding spoken word (graph, word) to the memory 312.

These graph-word combinations are then used to train the graph-to-syllable model, in step 5. The input to the graph-to-syllable model is a sequence of graphs and the output is a set of syllables which are associated with the facial movements converted from a grid-to-graph sequence. The process involves an encoder and a decoder where the encoder learns to compress a sequence of graphs into a latent space. The decoder then decompresses the sequence of graphs from the latent space to output one or more syllables. In an alternative embodiment, the dataset that is captured in step 1 to step 4 can be transferred to a cloud computing system and a machine learning model is trained in the cloud computing system.

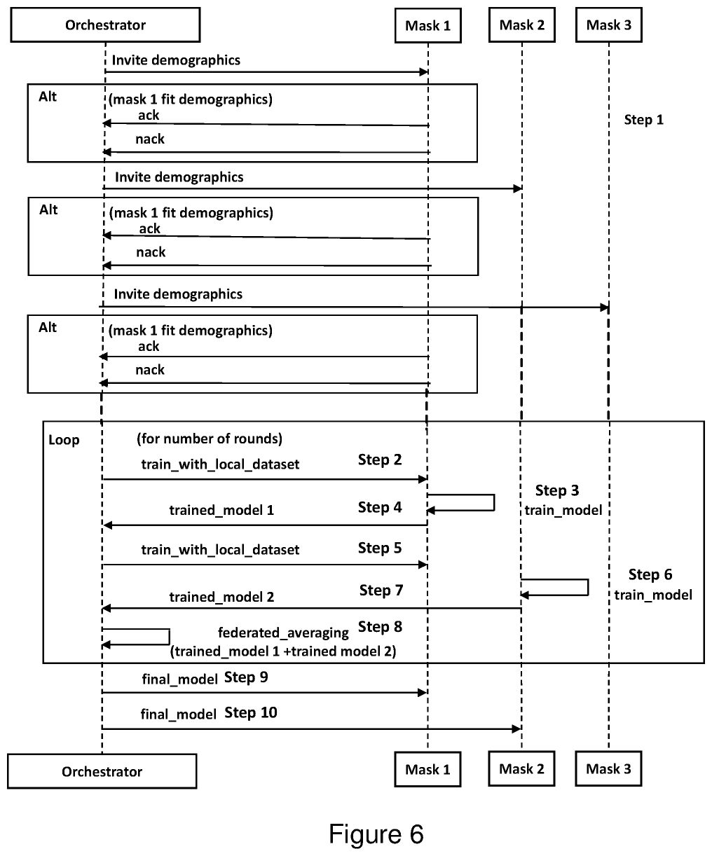

In addition, federated learning techniques may be implemented to train a decentralized version of the machine learning model where data is collected from personalized machine learning models from multiple wearers with common vocabularies. Wearers are grouped by demographics, such as by gender, age, etc. and afterwards a new demography specific machine learning model is produced for wearers in different demographic groups through federated averaging. A sequence diagram illustrating an example federated training process is shown in FIG. 6. The federated training process produces the demography specific machine learning model for a demographic group through federated averaging. In this example, the federated training process involves an orchestrator, a face mask 1, a face mask 2, and a face mask 3. In step 1, the orchestrator invites the face mask 1, the face mask 2, and the face mask 3 if it fits the demographic group. However, in this example the face mask 3 does not fit the demographic group. In step 2, the orchestrator trains the face mask 1 with a local data set. The face mask 1 trains its model, in step 3. In step 4, the face mask 1 returns a trained model 1 to the orchestrator. In step 5, the orchestrator trains the face mask 2 with a local data set. The face mask 2 trains its model, in step 6. In step 7, the face mask 2 returns a trained model 2 to the orchestrator. In step 8, the orchestrator applies federated averaging on trained model 1 and trained model 2 to produce a new shared model for the demographic group, i.e., the face mask 1 and the face mask 2. In step 9 and step 10, the orchestrator sends the final model, i.e., the demography specific machine learning model to the face mask 1 and face mask 2, respectively.

It should be noted that alternatively, personalized machine learning models that are associated with face masks that fit into a demographic group may be collated centrally by a cloud service. These personalized machine learning models may then be used to prepare demography specific machine learning models. In an example, classifications from a personalized machine learning model are preferred over a collaborative training model or a demography specific machine learning model as the personalized machine learning model is trained for a wearer. However, in the event of lack of sufficient data from personalized machine learning models, collaborative training model or demography specific machine learning models may be used for classifications.

In an embodiment, the face mask 200 comes pre-installed with graph-to-syllable models that have already been trained to classify the data representing the changes in shape of the part of the face of the wearer into units of speech. For example, a graph-to-syllable model pre-installed in a face mask 200 may be a demography specific machine learning model. The pre-installed model may be re-trained to become more wearer-specific or a separate model is trained and then the pre-installed model is combined with the wearer's separate model. In addition to pre-installed graph-to-syllable models, the face mask 200 can be trained for specialized uses in limited contexts, for example, a niche technical environment, such as a medical environment, that uses frequent and specific vocabulary. The specific vocabulary used in the niche technical environment may be in addition to the personal vocabulary specific to the wearer. In such cases, machine learning model associated with the face mask 200 is trained with predefined vocabularies that may be in regular use in the niche technical environment. Then, the machine learning model associated with the face mask 200 can be further trained by the wearer only for words associated with the niche technical environment. The wearer trains the machine learning model for the niche technical environment by uttering each word while the face mask 200 generates strain maps. The strain maps may then be converted to a graph and then a graph-to-syllable model will learn to associate graphs with syllables, i.e., the syllables used in building words for the specific vocabulary. The face mask 200 which is pre-installed with graph-to-syllable models mitigates the extent of training required to calibrate the face mask 200 to the wearer's speech. In this example the machine learning model is built for the niche technical environment. However, without limitation, it is noted that the machine learning model can similarly be trained by the wearer in generic contexts as well.

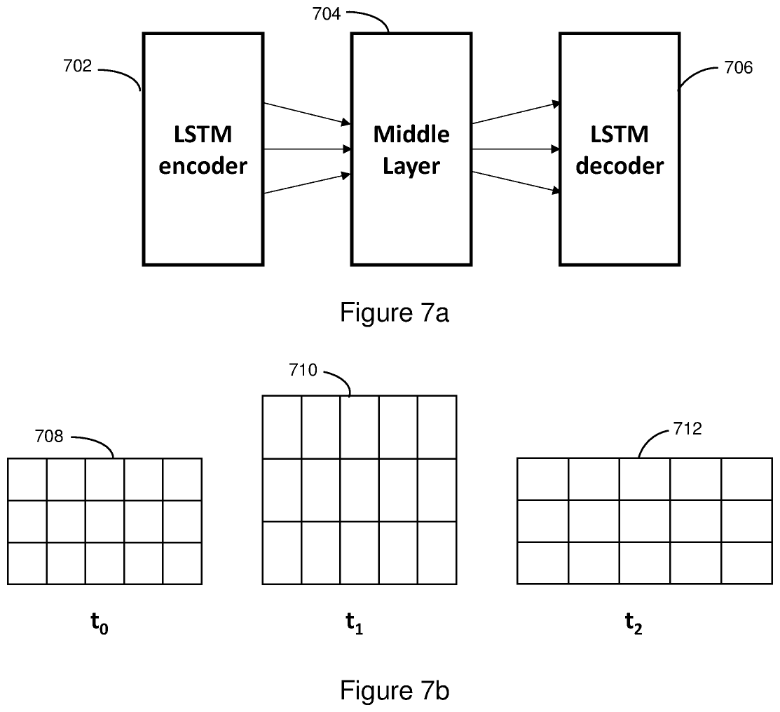

FIG. 7a graphically depicts a sequence-to-sequence model architecture of a Long Short-Term Memory (LSTM) encoder 702 and an LSTM decoder 706. The sequence-to-sequence model is trained to associate a sequence of graphs to a syllable. The LSTM encoder 702 is used to create embeddings from input distances provided by the different graphs at different points in time, such as graph to 708, graph t₁ 710, and graph t₂ 712, as illustrated in FIG. 7b. Each of the graphs, graph to 708, graph t₁ 710, and graph t₂ 712 correspond to different shapes of the face plotted in different points in time when the wearer speaks a word. The distance in the graphs is the relative difference between standard and measured values in the graph. The LSTM encoder then associates the embeddings in a sequence. Embeddings are algorithms used in graph pre-processing to turn a graph into a computationally identifiable format, i.e., in a vector space. In this context, embeddings are used to transform nodes, edges, and their features into vector space for enabling the sequence-to-sequence model to identify inputs from the graphs. A bottleneck layer 704 (also known as a middle layer) is designed to compress the embeddings sequence in a smaller state space which may correspond to a subset of syllables The LSTM decoder 706 is designed to reconstruct what has been captured by the bottleneck layer 704, i.e., the syllables or words. Based on the reconstruction loss, which is a root mean squared average between the captured embedding and the actual input, the sequence-to-sequence model is retrained to decrease the loss, thereby improving at associating the graphs with syllables.

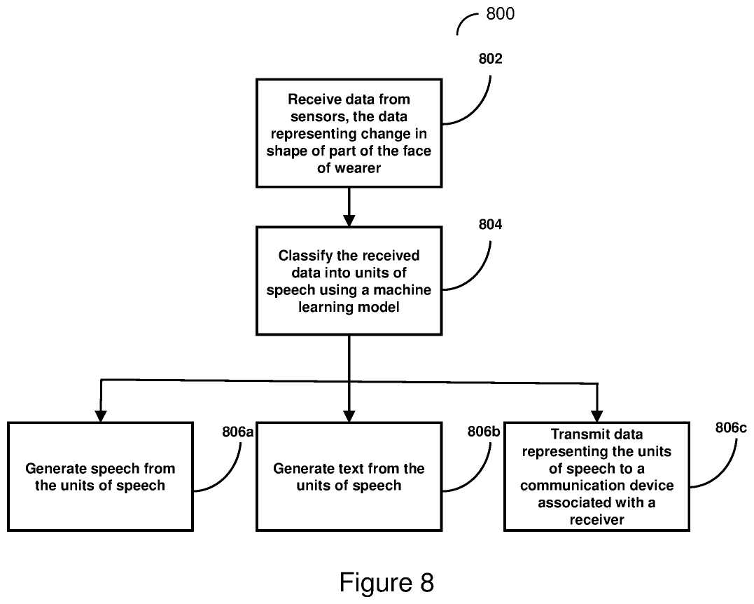

FIG. 8 illustrates a flowchart of a method 800 by the face mask 200 capturing speech produced by a wearer of the face mask 200, in accordance with some embodiments of the present disclosure. The method 800 includes receiving 802 data from an array of sensors 202 comprised in the face mask, the data representing the changes in shape of a part of a face of the wearer while producing speech. The data received from the array of sensors 202 is classified 804 into units of speech using a machine learning model. The method 800 may then generate 806a speech from the units of speech. Alternatively, the method 800 may generate 806b text from the units of speech. A communications device 316 communicatively connected to the face mask 200 may generate the speech or the text from the units of speech. The speech or the text may alternatively be generated from the units of speech on a cloud computing system. In another alternative, data representing the units of speech is transmitted 806c to a communication device associated with a receiver. The communication device associated with the receiver then generates the speech or the text from the units of speech.

In an embodiment, the face mask 200 may be configured to capture expressions of the wearer from changes in shape of a part of a face of the wearer. The expressions of the wearer may include but are not limited to gestures or emotions. The face mask 200 includes the array of sensors 202 adapted to capture the changes in shape of the part of the face of the wearer and a processing circuitry adapted to receive data from the array of sensors 202. The data from the array of sensors 202 represents the changes in shape of the part of the face of the wearer. The data is classified using a machine learning model to capture an expression produced by the wearer, wherein the captured expression corresponds to the captured changes in shape of the part of the face of the wearer. In the context of the sequence-to-sequence model as depicted in FIG. 7, the expression may be a graph. This graph may be decoded into a representation of each expression such as, for example an emoticon or a unique symbolic label of each expression that the sequence-to-sequence model is tasked to learn.

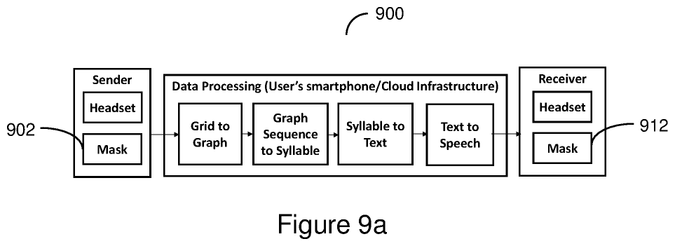

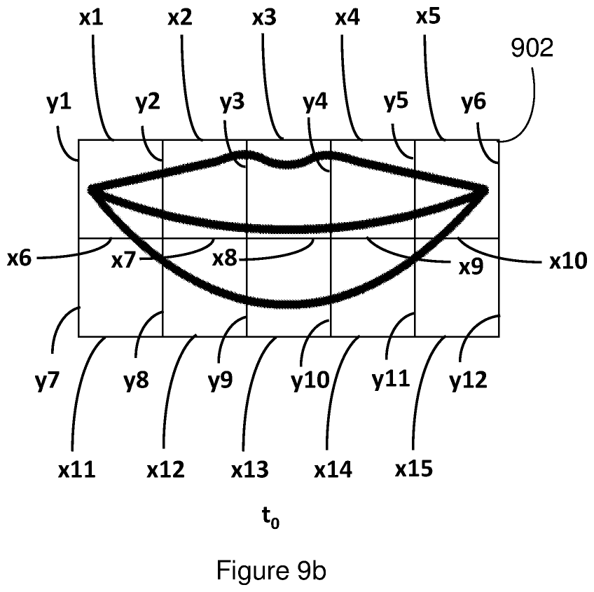

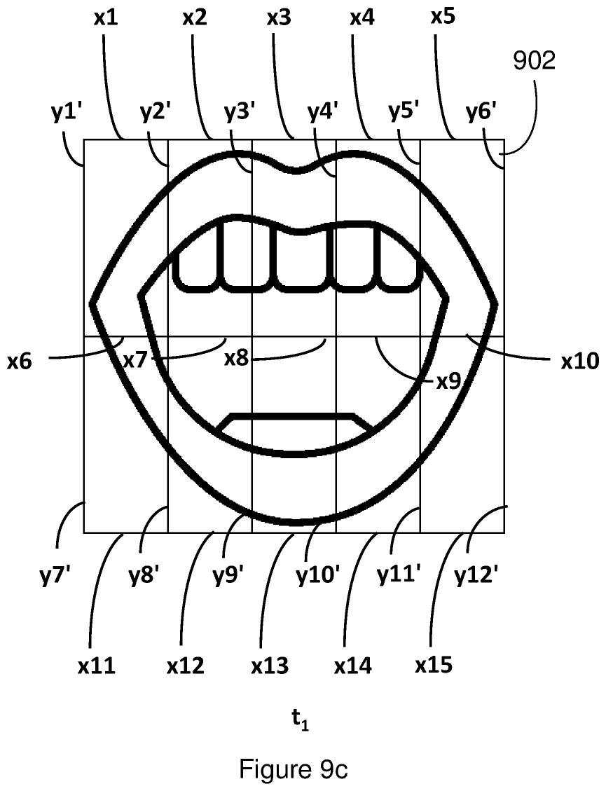

FIG. 9a is a block diagram illustrating a data processing system 900, where data transmitted between a sender's face mask 902 and a receiver's communication device is processed. Data processing comprises generating speech or text from the units of speech. For example, the units of speech in the form of phonemes, phones, syllables, articulations, utterances, vowels, or consonants, may be used to generate speech or text. In an embodiment, the data processing is performed on the communications device 316 communicatively connected to the face mask 200. In another embodiment, the data processing is performed on a cloud computing system. In yet another embodiment, the data processing is performed in a hybrid environment comprising both a cloud computing system and the communications device 316. The sender's face mask 902 is communicatively connected to a sender's communications device (not shown in FIG. 9a). Similarly, the receiver's face mask 912 is communicatively connected to a receiver's communications device (not shown in FIG. 9a). The sender's face mask 902 transmits data representing the changes in shape of a part of a face of the sender, in form of a coordinate matrix with information from different affected sensors disposed along the layer of the face mask 902. The data is transferred from the face mask 902 to the sender's communications device.

The data is then converted into a graph. The graph captures one or more locations of affected sensors and the corresponding measurements. For example, changes in strain values corresponding to changes in the shape of the part of the face, in a sensor may be measured in voltage. FIG. 9b exemplarily illustrates a wireframe connecting different affected sensors in a face mask affected by movement of facial muscles in time step 0 (t₀). The graph at time t₀ considers distances between each of the affected sensors, in this case horizontal distances x1 to x15 and vertical distances y1 to y12. Taking into consideration movement of facial muscles in time step 1 (t₁), the vertical distances between the affected sensors may change while the horizontal distances remain unaffected. The model associates the sequences of graphs to syllables. In an example, the sender pronounces the vowel “a”. In the graph, a corresponding change is affected. In this example, the vertical distances between each of the affected sensors are updated as y1′ to y12′. The wireframe connecting different sensors in the face mask 902 affected by movement of facial muscles in time step 1 (t₁), is exemplarily illustrated in FIG. 9c.

In an example, the changes in affected sensors as illustrated in FIG. 9b provides a variance to the machine learning model. Variance in the machine learning model is a measure of variation in strain values in affected sensors and distance between each affected sensor in comparison to expected strain values and distance. These changes are captured over time as the wearer's face moves while using the face mask 200. Variance improves the adjustability of the machine learning model to changes in input data during encoding and decoding the graphs to syllables.

In an embodiment to associate the sequences of graphs to syllables, for example vowel “a”, and later to words, the sequence-to-sequence model as described in conjunction with the description of FIG. 7, is trained. The sequence-to-sequence model takes as input a sequence of graphs and learns to associate the sequence of graphs with another sequence, such as a sentence. In this example, speech is generated from syllables. However, without limitation, the speech may also be generated from other units of speech including phonemes, phones, syllables, articulations, utterances, vowels, and consonants, or a combination thereof. The generated speech, in an example, may be played out using a loudspeaker in the receiver's headset.

In an embodiment, the face mask 200 comprises a gesture-to-talk-interface for initiating transmission of speech of the sender. The sender's facial muscles' lineation representing speech is followed by a gesture, such as a long pause, where the face mask 200 will simply rest on the sender's still face. In response to the gesture, the face mask 200 triggers transmission of the sender's speech to the receiver, in a manner akin to a push-to-talk device.

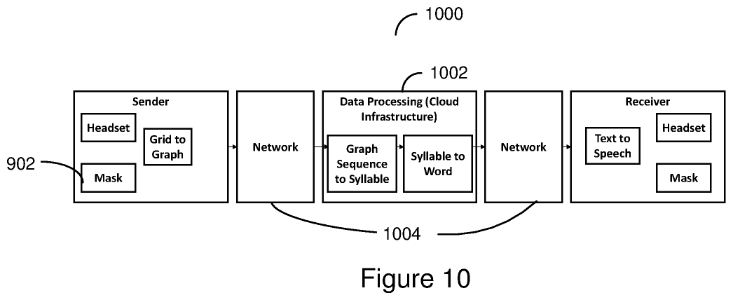

FIG. 10 is a block diagram illustrating a data processing system 1000, where data transmitted between the sender's face mask 902 and the receiver's communication device is processed in a cloud computing system 1002. In an embodiment, the sender's face mask 902 is communicatively connected to a communications device (not shown in FIG. 10). The communications device enables the face mask 902 to transmit the data over a network 1004 to cloud computing system 1002. The data representing the changes in shape of the part of the face of the sender is represented in the form of adjacency matrices. In this example, speech is generated from syllables (units of speech) in a cloud computing system, i.e., the conversion of data representing the changes in shape of the part of the face of the sender from graphs to syllables to text takes place in cloud computing system 1002. Therefore, the processing of data is offloaded from the communications device to cloud computing system 1002, improving the battery life of the communications device. Cloud computing system 1002 may generate words in the form of text, which consumes lower network bandwidth as opposed to words represented acoustically. In this embodiment, the text-to-speech conversion is performed in a communication device communicatively connected to the receiver's face mask 912, which is then played out using the loudspeaker in the receiver's headset.

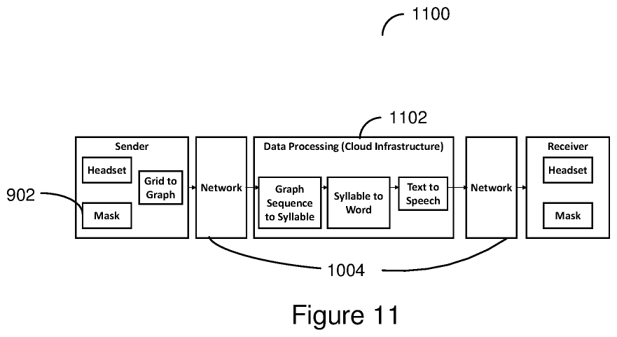

In an alternative embodiment, the text-to-speech conversion may also be performed in a cloud computing system. A block diagram illustrating a data processing system 1100, where data transmitted between the sender's face mask 902 and the receiver's communication device is processed and text-to-speech is converted in a cloud computing system 1102, is shown in FIG. 11. In this embodiment, the generation of text from syllables as well as text-to-speech conversion takes place in the cloud computing system 1102.

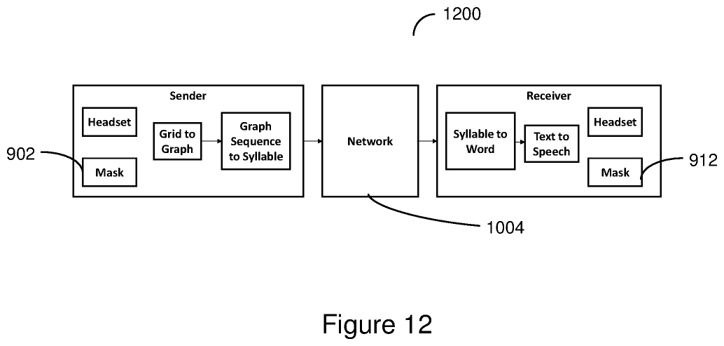

FIG. 12 is a block diagram illustrating steps involved in processing of data transmitted between the sender's face mask 902 and the receiver's communication device over a network 1004 in a personal device environment 1200, i.e., on communications devices (not shown in FIG. 12) communicatively connected to the sender's face mask 902 and the receiver's face mask 912. In the personal device environment 1200, at least two communication devices such as mobile phones are connected to each other. In this embodiment, the data representing the changes in shape of the part of the face of the wearer is entirely processed on the communications devices. In this example, the data received from the face mask 902 is classified into syllables using a machine learning model. The communication device communicatively connected to the receiver's face mask 912 generates text from syllables and then converts text-to-speech. Alternatively, the communication device may directly generate speech from the syllables. The use of the communication devices for data processing offers a more private environment since no user information is transmitted outside of the communications devices.

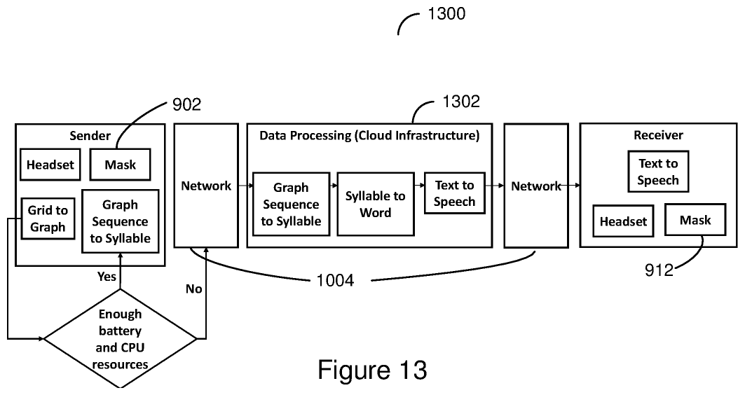

FIG. 13 is a block diagram illustrating steps involved in processing of the data transmitted between the sender's face mask 902 and the receiver's communication device in a hybrid environment 1300, i.e., a combination of a cloud computing system and personal devices. In this embodiment, the data is processed partly on communications devices (not shown in FIG. 13) communicatively connected to the sender's face mask 902 and the receiver's face mask 912 and partly performed in a cloud computing system 1302. In this embodiment, the sender's face mask 902 produces the graphs. However, the data processing is conditionally off-loaded to the cloud computing system 1302 if the communications device communicatively connected to the sender's face mask 902 does not meet the requirements for processing. For example, if the communications device has a low battery or if the processing power of the communications device is determined not adequate to meet the data processing requirements to run machine learning models for converting the graphs to syllables, the data processing is offloaded to the cloud computing system 1302.

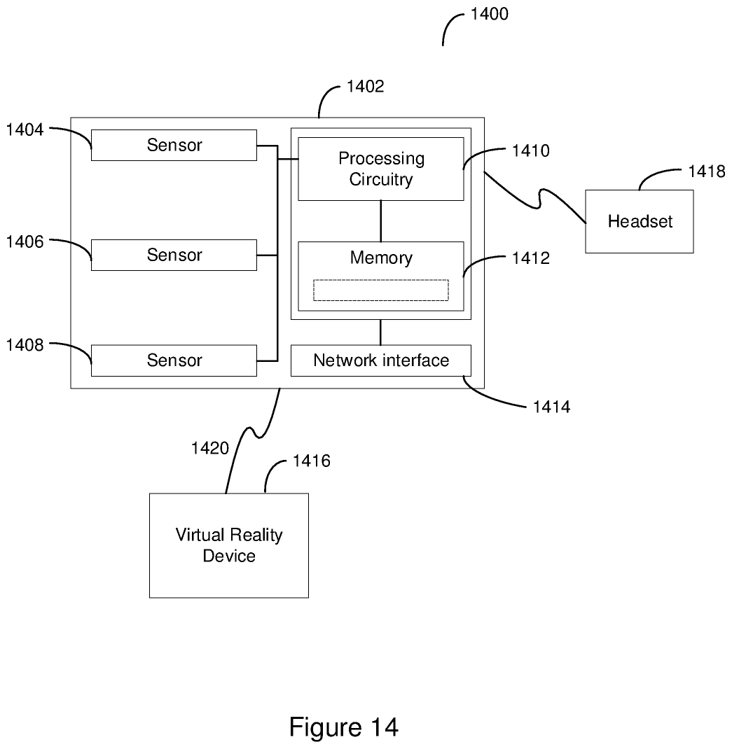

FIG. 14 schematically illustrates a system 1400 comprising a face mask 1402 that is communicatively connected 1420 to a Virtual Reality (VR) device 1416 and a headset 1418 through any short-range communications protocol and configured to operate in accordance with some embodiments of the present disclosure. The face mask 1402 comprises sensors, i.e., a sensor 1404, a sensor 1406, and a sensor 1408, a processing circuitry 1410 adapted to receive data from the sensors, a memory 1412 coupled to the processing circuitry 1410, a network interface 1414 to enable communications between the face mask 1402, the VR device 1416 and the headset 1418. In this context, the face mask 1402 receives data from the sensors, the data representing the changes in shape of the part of the face of the wearer. The wearer may, for example issue input commands to the VR device 1416. The processing circuitry 1410 classifies the data into units of speech using a machine learning model. In this example, the data representing the units of speech is transmitted to the VR device 1416, which is adapted to generate speech and text from the units of speech. The speech may, in an example, be represented acoustically, which forms an input command to the VR device 1416. It should be noted that in system 1400, Augmented Reality (AR) devices and Mixed Reality (MR) devices may also be used in place of VR device 1416.

Potential advantages of one or more of these embodiments may include that the face mask is able to capture speech produced by the wearer of the face mask using sensors adapted to capture changes in shape of a part of a face of the wearer while speaking. Therefore, the need for ambient noise cancellation to mitigate unwanted background noise from the wearer is eliminated. Further, the need for invasive prosthetics is obviated since the speech produced by the wearer is captured from the data received from the sensors in the face mask as opposed to devices mounted within the wearer's body.

In the above description of various embodiments of present inventive concepts, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belongs. It will be further understood that terms, such as those defined in commonly used dictionaries, should be interpreted as having a meaning that is consistent with their meaning in the context of this specification and the relevant art and will not be interpreted in an idealized or overly formal sense expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another clement, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

It will be understood that although the terms first, second, third, etc. may be used herein to describe various elements/operations, these elements/operations should not be limited by these terms. These terms are only used to distinguish one element/operation from another clement/operation. Thus, a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est.” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry.” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the presented embodiments are intended to cover all such modifications, enhancements, and other embodiments, which fall within the spirit and scope of present inventive concepts.

1-16. (canceled)

17. A face mask for capturing speech produced by a wearer of the face mask, the face mask comprising:
a plurality of sensors adapted to capture changes in shape of a part of a face of the wearer while producing speech; and
a processing circuitry configured to:
receive data from the plurality of sensors, the data representing the changes in shape of the part of the face of the wearer; and
classify the data received from the plurality of sensors into one or more units of speech using a machine learning model.

18. The face mask according to claim 17, wherein speech and/or text is generated from the units of speech.

19. The face mask according to claim 18, wherein the speech and/or the text is generated by a communication device communicatively connected to the face mask.

20. The face mask according to claim 18, wherein the speech and/or the text is generated by a cloud computing system.

21. The face mask according to claim 17, wherein the processing circuitry is further configured to transmit data representing the units of speech to a communication device associated with a receiver.

22. The face mask according to claim 17, wherein the units of speech comprise one or more of: phonemes, phones, syllables, articulations, utterances, vowels, and consonants.

23. The face mask according to claim 17, wherein the machine learning model is trained for the wearer.

24. The face mask according to claim 17, wherein the machine learning model is produced by collating machine learning models trained for a plurality of wearers.

25. The face mask according to claim 17, wherein the machine learning model is produced for a plurality of wearers in a demographic group through federated averaging.

26. The face mask according to claim 17, wherein the plurality of sensors is configured to continuously capture the changes in shape of the part of the face of the wearer while producing speech.

27. The face mask according to claim 17, wherein the data representing the changes in shape of the part of the face comprises one or more of:
distances between the plurality of sensors; and
positions of the plurality of sensors.

28. A method by a face mask for capturing speech produced by a wearer of the face mask, the method comprising:
receiving data from a plurality of sensors comprised in the face mask, the data representing changes in shape of a part of a face of the wearer while producing speech; and
classifying the data received from the plurality of sensors into one or more units of speech using a machine learning model.

29. The method of claim 28, wherein speech and/or text is generated from the units of speech, wherein the speech and/or the text is generated by:
a communication device communicatively connected to the face mask; or
a cloud computing system.

30. The method of claim 28, further comprising transmitting data representing the units of speech to a communication device associated with a receiver.

31. The method of claim 28, wherein the units of speech comprise one or more of:
phonemes, phones, syllables, articulations, utterances, vowels, and consonants.

32. The method of claim 28, wherein the machine learning model is trained for the wearer.

33. The method of claim 28, wherein the machine learning model is;
produced by collating machine learning models trained for a plurality of wearers; or
produced for a plurality of wearers in a demographic group through federated averaging.

34. The method of claim 28, further comprising continuously capturing, by the plurality of sensors, the changes in shape of the part of the face of the wearer while producing speech.

35. The method of claim 28, wherein the data representing the changes in shape of the part of the face comprises one or more of:
distances between the plurality of sensors; and
positions of the plurality of sensors.

36. A non-transitory computer readable medium on which is stored a computer program for capturing speech produced by a wearer of a face mask, the computer program comprising instructions that, when executed by at least one processor of the face mask, cause the face mask to:
receive data from a plurality of sensors comprised in the face mask, the data representing changes in shape of a part of a face of the wearer while producing speech; and
classify the data received from the plurality of sensors into one or more units of speech using a machine learning model.
